(19) United States
(12) Patent Application Publication
(10) Pub. No.: US 2018/0141024 A1
(43) Pub. Date: May 24, 2018

(54) Molded Adsorbents and Canisters Containing the Molded Adsorbents

(71) Applicant: AISAN KOGYO KABUSHIKI KAISHA, Obu-shi (JP)

(72) Inventors: Shinya Takeshita, Chiryu-shi (JP); Norihisa Yamamoto, Aichi-gun (JP)

(73) Assignee: AISAN KOGYO KABUSHIKI KAISHA, Obu-shi (JP)

(21) Appl. No.: 15/821,908

(22) Filed: Nov. 24, 2017

(30) Foreign Application Priority Data
Nov. 24, 2016 (JP) 2016-227610

(51) Int. Cl. B01J 20/28; F02M 25/08; B01D 53/04

(52) U.S. Cl. CPC B01J 20/28042; F02M 25/0854; B01D 2253/34; B01J 20/28004; B01D 2253/304; B01D 53/0415

(57) ABSTRACT

A molded adsorbent for adsorbing and desorbing fuel vapor includes a solid or hollow columnar shaped body. At least one of the axially opposite end surfaces of the molded adsorbent includes an inclined cut surface portion oriented at an acute angle relative to the longitudinal axis, a concave cut surface portion, or a convex cut surface portion.

### CROSS-REFERENCE TO RELATED APPLICATIONS

This application claims benefit of Japanese Patent Application Serial No. 2016-227610 filed on Nov. 24, 2016, and entitled “Molded Adsorbents and Canisters Containing the Molded Adsorbents,” which is hereby incorporated by reference in its entirety for all purposes.

### STATEMENT REGARDING FEDERALLY SPONSORED RESEARCH OR DEVELOPMENT

Not applicable.

### BACKGROUND

The disclosure generally relates to molded adsorbents and canisters containing the molded adsorbents.

In general, a vehicle, such as an automobile, may be provided with a canister that contains an adsorbent. The adsorbent can adsorb fuel vapor generated in a fuel tank for preventing the fuel vapor form being dissipated to the atmosphere. More specifically, the canister may temporarily capture fuel vapor produced, for example, when an internal combustion engine is stopped, through adsorption of the fuel vapor by the adsorbent contained in the canister. When the engine is restarted, the fuel vapor adsorbed by the adsorbent may be desorbed via a negative pressure in the intake of the engine such that the desorbed fuel vapor may be introduced into the engine and burned in the engine.

### BRIEF SUMMARY

In one aspect according to the present disclosure, a molded adsorbent capable of adsorbing and desorbing fuel vapor may have a solid or hollow columnar shaped body with a longitudinal axis and axially opposite end surfaces. At least one of the axially opposite end surfaces may include an inclined cut surface portion inclined relative to the longitudinal axis or may include at least one concave/convex cut surface portion.

Therefore, in the case where a plurality of molded adsorbents are filled into a canister, it may be possible to ensure adequate gaps between the molded adsorbents positioned adjacent to each other, by the at least one inclined cut surface portion or the at least one concave/convex cut surface portion provide on at least one of the axially opposite end surfaces of each of the molded adsorbents. Hence, fuel vapor can flow through the canister across substantially the entire space of the canister having the molded adsorbents filled therein, so that an increase in the resistance against flow of fuel vapor can be inhibited. Further, because the at least one inclined cut surface portion or the at least one concave/convex cut surface portion may increase a surface area of the at least one of the axially opposite end surfaces of each molded adsorbent, it is possible to improve the adsorption/desorption ability of the molded adsorbent.

In one embodiment, the molded adsorbent may have a hollow shape and may include a plurality of hollow spaces that are separated from each other by at least one partition wall extending in an axial direction.

In another embodiment, the molded adsorbent may include a plurality of inclined cut surface portions that jointly form a serrated (corrugated) shape, a wave shape, a convex or concave V-shape.

In a further embodiment, the molded adsorbent may have an outer diameter of from 4.0 mm to 6.0 mm. In other words, the outer diameter may be within a range of 4 mm and 6 mm including 4.0 mm and 6.0 mm.

In another aspect according to the present disclosure, a canister may include a tank port communicating with a fuel tank, a purge port communicating with an internal combustion engine, an atmosphere port communicating with the atmosphere. The canister may further include a first adsorption chamber and a second adsorption chamber. The first adsorption chamber may contain a first adsorbent and may communicate with the tank port and the purge port. The second adsorption chamber may contain a second adsorbent and may be arranged between the first adsorption chamber and the atmosphere port with respect to a flow of fuel vapor from the tank port to the atmosphere port. Each of the first adsorbent and the second adsorbent can adsorb and desorb fuel vapor. The second adsorbent may include a plurality of molded adsorbents each having a solid or hollow columnar shape with a longitudinal axis and axially opposite end surfaces. At least one of the axially opposite end surfaces may include at least one inclined cut surface portion inclined relative to the longitudinal axis or at least one concave/convex cut surface portion.

With this arrangement, the molded adsorbents of the second adsorbent may have an improve adsorption/desorption ability and can ensure adequate gaps between the molded adsorbents. Further, the molded adsorbents are contained in the second adsorption chamber, the adoption/desorption performance of which may greatly influence the blow-out phenomenon of the fuel vapor from the canister. Therefore, it is possible to reliably prevent the fuel vapor from being blown to the atmosphere out of the canister. Further, it is possible to substantially completely adsorb fuel vapor even in the case where a relatively large amount of fuel vapor has flown into the canister during refueling.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of the preferred embodiments of the invention, reference will now be made to the accompanying drawings in which:

FIG. 1 is a cross sectional side view of an embodiment of a canister for holding a molded adsorbent in accordance with principles described herein;

FIG. 2 is a perspective view of an embodiment of a molded adsorbent in accordance with principles described herein;

FIG. 3 is a cross sectional side view of the molded adsorbent of FIG. 2 taken along a plane including a longitudinal axis of the molded adsorbent;

FIG. 4 is a cross sectional side view of an embodiment of a molded adsorbent taken along a plane including the longitudinal axis of the molded adsorbent;

FIGS. 5 to 12 illustrate perspective views of embodiments of molded adsorbents in accordance with principles described herein;

FIG. 13 is a cross sectional side view of the molded adsorbent of FIG. 12 taken along a plane perpendicular to the longitudinal axis of the molded adsorbent; and

FIG. 14 is a cross sectional side view of an embodiment of a canister for holding a molded adsorbent in accordance with principles described herein.

### DETAILED DESCRIPTION OF EXEMPLARY EMBODIMENTS

As previously described, vehicles may be provided with a canister that contains an adsorbent for adsorbing and desorbing fuel vapors. Various materials, such as activated carbon, having pores for adsorption and desorption of fuel vapor have been used as adsorbent materials. The adsorbent material is often contained within a canister. For example, JP-A-2009-79595 discloses a use of a molded adsorbent that is molded from adsorbent powder into a tubular shape or a honeycomb shape for adjusting the quantity of the adsorbent per unit volume of the canister. However, the adsorbent molded into a complex shape, such as a honeycomb shape as disclosed in JP-A-2009-79595, may have a relatively large size. In addition, many molded adsorbents are shaped with axially opposite end surfaces cut in a direction perpendicular to the longitudinal axis of the molded adsorbent, and therefore, the axially opposite end surfaces are generally planar. Therefore, if a plurality of molded adsorbents are disposed in the canister, the planar ends may come into flush contact. When this occurs, gaps between the molded adsorbents positioned adjacent to each other may become very small, potentially increasing the resistance to flow of fuel vapor through the canister or cause an unevenness in the flow of fuel vapor, resulting in a degradation of the canister performance. Accordingly, there is a need in the art for molded adsorbents that can ensure sufficient gaps therebetween when stacked in canisters.

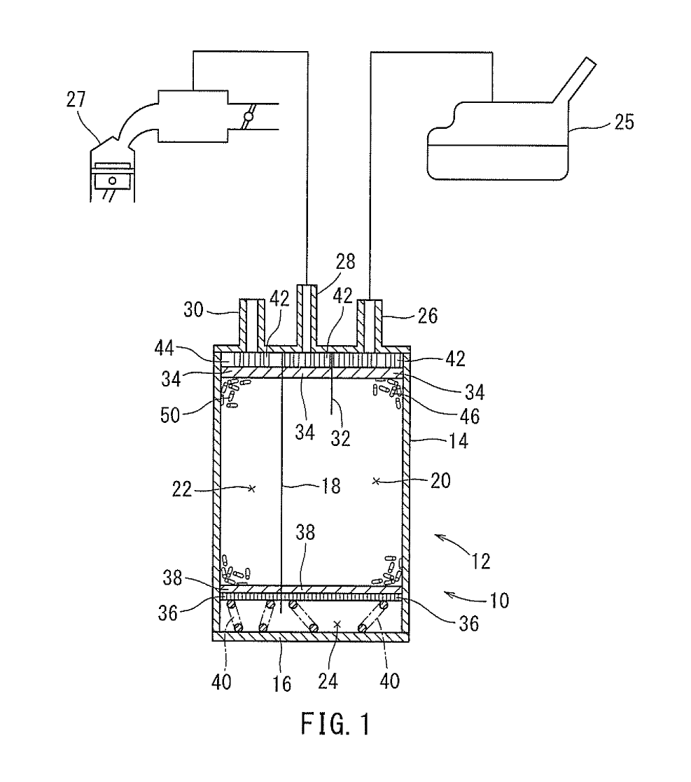

Referring to FIG. 1, there is shown a canister 10 used for a vehicle, such as an automobile. In the following description, the up, down, left and right directions will be determined based on the directions as viewed in FIG. 1. However, these directions are determined only for the purpose of clarity and further explanation, and do not intend to limit the directions of the canister 10 when installed on the vehicle. The canister 10 includes a casing 12 that may be made of resin. The casing 12 may include a case body 14 and a closure member 16. The case body 14 may have a bottomed rectangular tubular shape. The closure member 16 may close the open end of the case body 14. The internal space of the case body 14 may be divided into a main chamber 20 and an auxiliary chamber 22 by a partitioning wall 18. The main chamber 20 and the auxiliary chamber 22 may communicate with each other via a communication passage 24 that is defined in the lower portion of the case body 14. In this way, a U-shaped gas passage is formed in the case body 14 by the main chamber 20, the auxiliary chamber 22, and the communication passage 24.

A tank port 26 in communication with the internal space of a fuel tank 25, a purge port 28 in communication with an intake passage of an internal combustion engine 27, and an atmosphere port 30 open to the surrounding environment are formed on the upper end wall of the case body 14. The tank port 26 and the purge port 28 may communicate with the main chamber 20, while the atmosphere port 30 may communicate with the auxiliary chamber 22.

A dividing wall 32 may be disposed in the upper portion of the main chamber 20 for dividing the upper portion into a right region communicating with the tank port 26 and a left region communicating with the purge port 28. Filters 34 may be disposed at the upper ends of the right and left regions, respectively. Perforated plates 36 may be disposed at the lower ends of the main chamber 20 and the auxiliary chamber 22. Filters 38 may be disposed on the upper surfaces of the perforated plates 36 in a layered manner. One or more springs 40 may be interposed between the closure member 16 and the perforated plates 36. The springs 40 may be coil springs and may urge the perforated plates 36 upward. Each of the filters 34, 38 may be formed of a non-woven resin cloth, urethane foam, etc. A plurality of pin-shaped projections 42 may protrude downward from the lower surface of the upper end wall of the case body 14 for holding the filters 34 from the upper side. Therefore, a plurality of spaces 44 are defined between each filter 34 and the upper end wall of the case body 14 for communicating with the corresponding port 26, 28, 30.

A plurality of molded adsorbents 46 in the form of pellets may be contained in a space defined between the filters 34 and the filter 38 of the main chamber 20. The molded adsorbents 46 may be molded from a mixture of activated carbon powder and a binder and may each have a cylindrical shape with a width or diameter from 1.0 mm to 3.0 mm and a length from 3.0 mm to 10.0 mm.

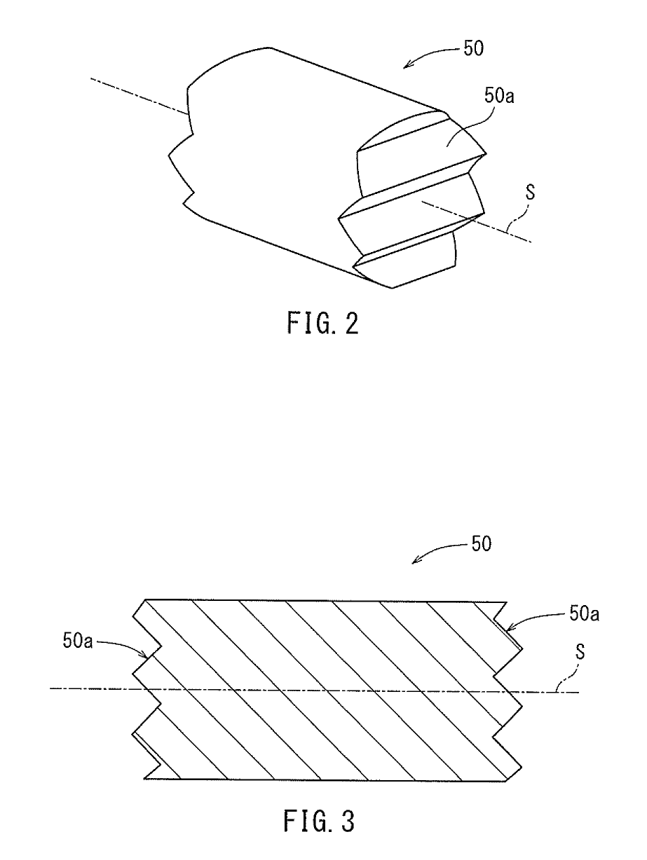

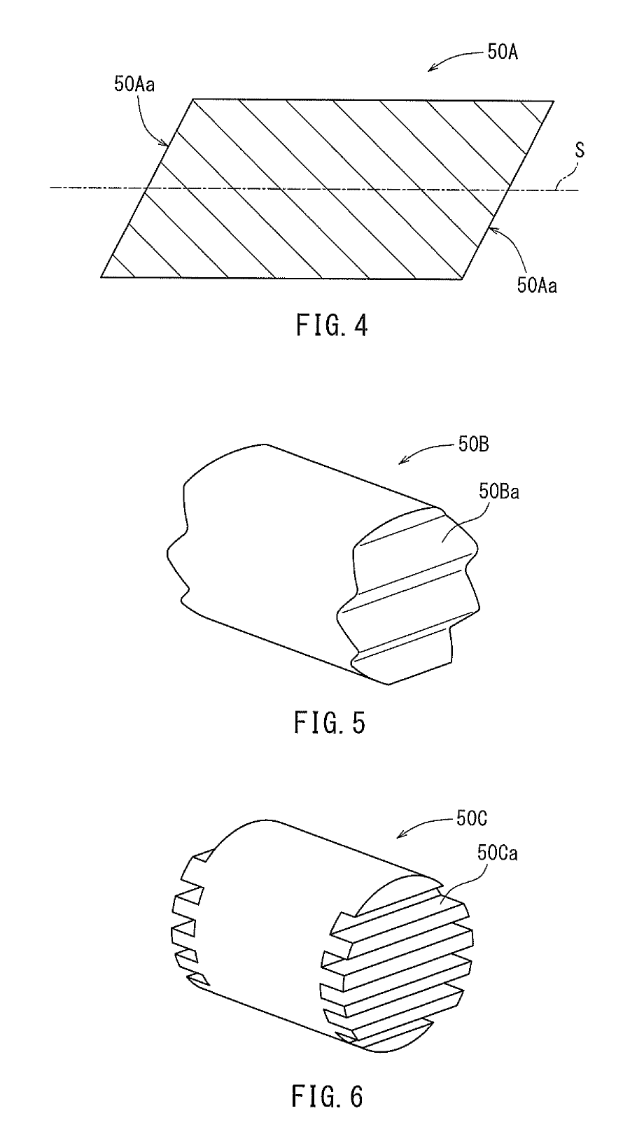

A plurality of molded adsorbents 50 in the form of pellets may be contained in a space defined between the filter 34 and the filter 38 of the auxiliary chamber 22. One of the molded adsorbents 50 is shown in FIGS. 2 and 3. The molded adsorbent 50 may be molded from a mixture of activated carbon powder and a binder and may each have a cylindrical shaped body with a longitudinal axis S. The molded adsorbent 50 may have a width or diameter from 4.0 mm to 6.0 mm and a length from 3.0 mm to 10.0 mm. In this embodiment, each of the opposite axial end surfaces 50a of the molded adsorbent 50 has a serrated shape (corrugated shape) including a plurality of inclined cut surface portions that are inclined (e.g., disposed at acute angles) relative to the longitudinal axis.

The molded adsorbents 50 may be manufactured by the following exemplary method. First, activated carbon powder is mixed with a binder, and the mixture is then extruded in a cylindrical shape by an extrusion molding machine (not shown). Thereafter, the extruded cylindrical mixture is cut into a plurality of cylindrical rods each having a predetermined length by using a cuter (not shown) having a blade with a serrated (corrugated) cutting surface. The cylindrical rods are thereafter fired to obtain the molded adsorbents 50. The manufacturing method may not be limited to the exemplary method but may include any other process steps, which may be well known in the art, than those of the representative method as long as a step of forming the serrated (corrugated) shapes on the opposite end surfaces 50a is included.

The molded adsorbents 50 molded as described above may each include the opposite end surfaces 50a with serrated (corrugated) shapes. Therefore, in comparison with a molded adsorbent having flat opposite end surfaces oriented perpendicular to the longitudinal axis, the molded adsorbent 50 may have larger surface areas at the opposite end surfaces 50a. Hence, it is possible to increase the number of pores that may face gas (fuel vapor). As a result, the molded adsorbents 50 may be improved in the adsorption and desorption performance for the fuel vapor. Further, because the serrated (corrugated) shapes of the opposite end surfaces 50a can be formed by simply cutting the cylindrical mixture, it is possible to achieve an increase in the surface areas without need of an increases in the number of process steps for manufacturing the molded adsorbents 50. Further, because each of the molded adsorbents 50 have the opposite end surfaces 50a with serrated (corrugated) shapes, it may be possible to enhance the likelihood of adequate gaps between the molded adsorbents 50 that contact with each other, in comparison with molded adsorbents with flat opposite surfaces. As a result, an increase in the resistance against flow of gas may be avoided even in cases where the molded adsorbents 50 have been filled into the auxiliary chamber 20 at a relatively high density.

The shape of each opposite end surface 50a of the molded adsorbent 50 may not be limited to the serrated (corrugated) shape but may be any other shape as long as it includes an inclined cut surface portion inclined relative to the longitudinal axis S or a concave and/or convex cut surface portion. The shape of each opposite end surface 50a may be changed by changing a shape of the blade of the cutter in the above manufacturing method.

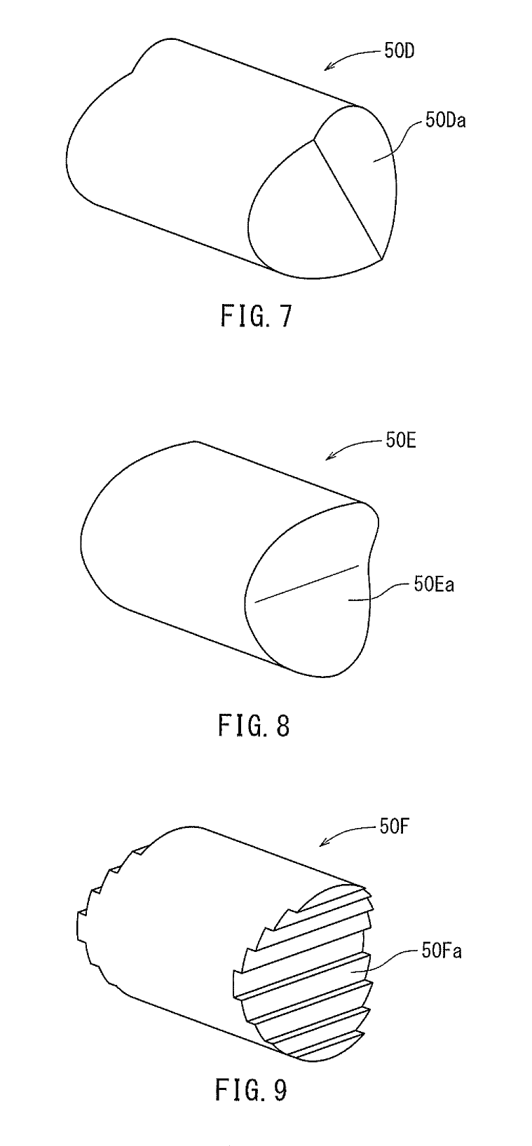

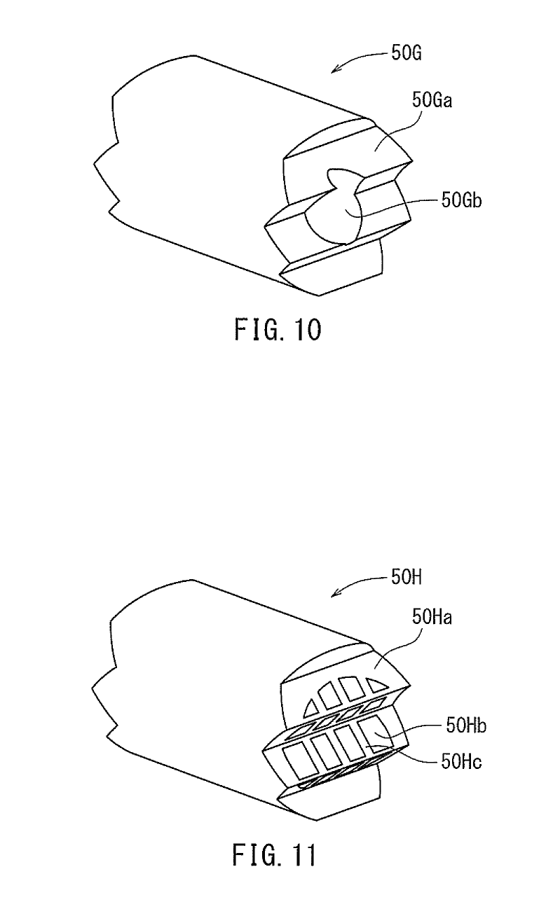

FIGS. 4 to 13 show various alternative embodiments of molded adsorbents 50A, 50B, 50C, 50D, 50E, 50F, 50G, 50H, 50I that can be used for adsorbents 50 previously described. In the embodiment shown in FIG. 4, opposite end surfaces 50Aa of a molded adsorbent 50A are configured as flat inclined cut surfaces inclined by a same angle relative to the longitudinal axis S. In other words, each of the opposite end surfaces 50Aa is a single flat inclined cut surface. The flat inclined cut surfaces can be formed by cutting the cylindrical mixture in a direction obliquely relative to the longitudinal axis of the cylindrical mixture by using a flat cutter blade. In the embodiment shown in FIG. 5, each of opposite end surfaces 50Ba of a molded adsorbent 50B is formed to have a wave shape. In the embodiment shown in FIG. 6, each of opposite end surfaces 50Ca of a molded adsorbent 50C is formed to have a concave and convex shape including a plurality of linear projections each having a rectangular cross section and arranged parallel to each other in the diametrical direction. In the embodiment shown in FIG. 7, one of opposite end surfaces 50Da of a molded adsorbent 50D is formed to have a convex V-shape including a pair of flat inclined cut surfaces intersecting at a ridge extending in the diametrical direction. The other of the opposite end surfaces 50Da is formed to have a concave V-shape including a pair of flat inclined cut surfaces intersecting at a bottom extending in the diametrical direction. In the embodiment shown in FIG. 8, one of opposite end surfaces 50Ea of a molded adsorbent 50E is formed to have a convex shape including a pair of curved inclined cut surfaces intersecting at a ridge extending in the diametrical direction. The other of the opposite end surfaces 50Ea is formed to have a concave shape including a pair of curved inclined cut surfaces intersecting at a bottom extending in the diametrical direction. In the embodiment shown in FIG. 9, one of opposite end surfaces 50Fa of a molded adsorbent 50F is formed to have a convex shape including a plurality of stepped convex cut surfaces. The other of the opposite end surfaces 50Fa is formed to have a concave shape including a plurality of stepped concave cut surfaces.

In each of the embodiments shown in FIGS. 2-9, the shape of one of the opposite end surfaces 50a (50Aa, 50Ba, 50Ca, 50Da, 50Ea, 50Fa) is complemental to the shape of the other of the opposite end surfaces. However, in other embodiments, the shapes of the opposite end surfaces 50a (50Aa, 50Ba, 50Ca, 50Da, 50Ea, 50Fa) may not be complemental to each other. Thus, the shapes of the opposite end surfaces may be the same or may not be complemental to each other. For example, one of the opposite end surfaces may be a flat surface extending perpendicular to the longitudinal axis S.

In the embodiments shown in FIG. 10, each of opposite end surfaces 50Ga of a molded adsorbent 50G has a serrated (corrugated) shape similar to the opposite end surfaces 50a of the embodiment shown in FIGS. 2 and 3. Similarly, each of opposite end surfaces 50Ha of a molded adsorbent 50H according to the embodiment shown in FIG. 11 has a serrated (corrugated) shape similar to the opposite end surfaces 50a of the embodiment shown in FIGS. 2 and 3. However, in the embodiment shown in FIG. 10, the molded adsorbent 50G has a cylindrical tubular shape including a hollow space 50Gb extending along the longitudinal axis. In the embodiment shown in FIG. 11, the molded adsorbent 50H includes a plurality of hollow spaces 50Hb. The hollow spaces 50Hb extend parallel to each other in the axial direction and are separated from each other by partitioning walls 50Hc that also extend parallel to each other in the axial direction.

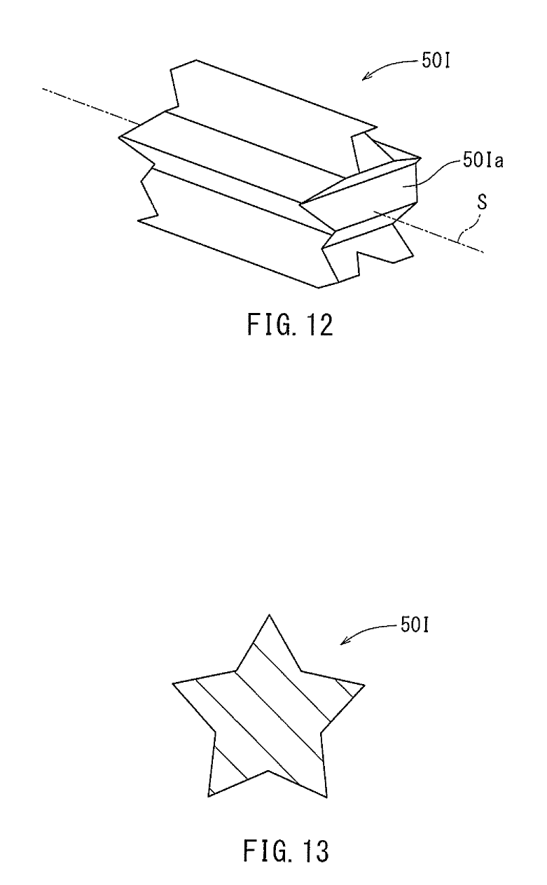

Embodiments of the molded adsorbents described herein (e.g., molded adsorbents 50, 50A, 50B, 50C, 50D, 50E, 50F) have a cylindrical shaped body, however, in other embodiments, the molded adsorbents may have a columnar shape other than cylindrical shaped body (e.g., rectangular prismatic). For example, in the embodiment shown in FIGS. 12 and 13, a molded adsorbent 50I has a columnar shaped body having a star-shaped cross section in a direction perpendicular to the longitudinal axis S.

By configuring the molded adsorbent to have a hollow shaped body as in the embodiments shown in FIGS. 10 and 11 or a non-cylindrical shaped body as in the embodiment shown in FIGS. 12 and 13, it is possible to increase the surface area as compared to a similarly sized (e.g., length and width/diameter) solid cylindrical shaped body.

The operation of the canister 10 shown in FIG. 1 will now be described. During stopping of the engine 27, fuel vapor evaporated in the fuel tank 25 or produced during refueling to the fuel tank 25 may be introduced into the main chamber 20 via the tank port 26. The fuel vapor may flow through the main chamber 20, the communication passage 24, and the auxiliary chamber 22 in this order, so that the fuel vapor may be adsorbed by the molded adsorbents 46, 50.

During driving of the engine 27, the intake negative pressure may be applied to the canister 10 via the purge port 28, so that the atmospheric air may be introduced into the auxiliary chamber 22 via the atmosphere port 30. The introduced atmospheric air may flow through the auxiliary chamber 22, the communication passage 24, and the main chamber 20 in this order, so that the fuel vapor adsorbed by the molded adsorbents 46, 50 may be desorbed. After that, the desorbed fuel vapor may be discharged from the purge port 28 together with the air so as to be supplied to the engine 27 where the fuel vapor may be burned.

The fuel vapor may be desorbed from the surfaces of the molded adsorbents 46, 50 by the atmospheric air flowing from the outside into the canister 10 via the atmospheric port 30. Because each of the molded adsorbents 50 has a relatively large surface area, the fuel vapor can be rapidly desorbed from the molded adsorbents 50. Therefore, the molded adsorbents 50 can rapidly recover their adsorption abilities. In other words, the molded adsorbents 50 offer the potential to maintain an adequate adsorption ability for adsorbing fuel vapor flown into the auxiliary chamber 22. As a result, it is possible to reliably prevent fuel vapor from flowing into the atmosphere via the atmospheric port 30 without being adsorbed by the molded adsorbents 50 contained in the auxiliary chamber 22.

Further, during refueling to the fuel tank 25, it may be possible that a relatively large amount of fuel vapor flows from the fuel tank 25 into the canister 10. In such a case, if the resistance against flow of gas through the canister 10 is high, there may be a risk that some of the fuel vapor cannot flow into the canister 10 but flows into the atmosphere from the fuel tank 25 via a refueling port. However, in embodiment described herein offer the potential to ensure an adequate volume of gaps between the molded adsorbents 50 contacting each other even in the case where the molded adsorbents 50 have been filled into the auxiliary chamber 22 at a high density. Hence, it is possible to inhibit an increase in the resistance against flow of gas. As a result, the canister 10 can allow inflow of a large amount of fuel vapor to prevent outflow of fuel vapor from the refueling port during refueling.

Although the operation of the canister 10 has been described in connection with the case where the molded adsorbents 50 are contained in the auxiliary chamber 22, the molded adsorbents 50 may be replaced with any one the molded adsorbents 50A to 50I or may be replaced with a combination of any two or more of the molded adsorbents 50 and 50A to 50I.

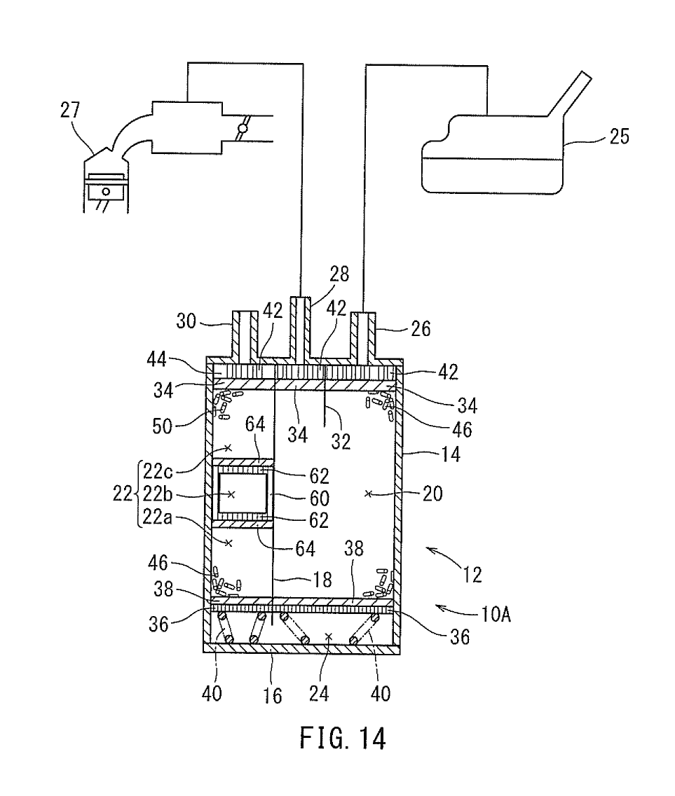

Referring to FIG. 14, another embodiment of a canister 10A is shown. The embodiment of canister 10A shown in FIG. 14 is a modification of the canister 10 previously described shown in FIG. 1. Therefore, in FIG. 14, like members are given the same reference numerals as those in FIG. 1 and the description of these members will be omitted. Canister 10A shown in FIG. 14 is different from the canister 10 in that the canister 10A is designed to be installed on the vehicle with its orientation being the same as shown in FIG. 14. In other words, the up and down directions as viewed in FIG. 14 correspond to the up and down directions of the canister 10A when installed on the vehicle. Therefore, when the canister 10A is installed on the vehicle, the ports 26, 28, 30 may be positioned at the upper end of the casing 12.

As shown in FIG. 14, the auxiliary chamber 22 of the canister 10A is divided into a first auxiliary chamber 22a, a second auxiliary chamber 22b, and a third auxiliary chamber 22c by a partitioning member 60. The partitioning member 60 includes upper and lower parallel perforated plates 62 connected to each other in the vertical direction. The second auxiliary chamber 22b is defined between the vertically-spaced perforated plates 62. Filters 64 are disposed on the lower surface of one of the perforated plates 62 facing the first auxiliary chamber 22a and on the upper surface of the other of the perforated plates 62 facing the third auxiliary chamber 22c.

In this embodiment, molded adsorbents 46 as previously described are contained in the first auxiliary chamber 22a, while the molded adsorbents 50 as previously described are contained in the third adsorption chamber 22c. However, no molded adsorbent is contained in the second auxiliary chamber 22b. Therefore, when the fuel vapor flows from the tank port 26 into the second auxiliary chamber 22b of the canister 10A after flowing through the main chamber 20, the communication passage 24, and the first auxiliary chamber 22a, the fuel vapor may be accumulated at the lower portion of the second auxiliary chamber 22b because the fuel vapor is heavier than air. Hence, the fuel vapor may not easily reach the third auxiliary chamber 22c.

Further, because the molded adsorbents 50 having a higher adsorption ability are contained in the third auxiliary chamber 22c, the fuel vapor can be reliably adsorbed by the molded adsorbents 50 when it reaches the third auxiliary chamber 22c. In addition, because the molded adsorbents 50 have a higher desorption ability, the fuel vapor desorbed by the molded adsorbents 50 can be easily desorbed. Therefore, it is possible to always keep the adsorption capacity for the fuel vapor in the third auxiliary chamber 22c at a higher level. As a result, the canister 10A is improved in the performance with respect to the prevention of fuel vapor flow being blown out of the canister 10A.

It should be appreciated that the molded adsorbents 50 in canister 10A may be replaced with any one or more of the molded adsorbents 50A to 50I of the alternative embodiments or may be replaced with a combination of any two or more of the molded adsorbents 50 and 50A to 50I.

The embodiments described herein may be further modified in various ways. For example, the material of the molded adsorbents 50 (50A to 50I) may not be limited to activated carbon but my be an inorganic adsorption material, such as silica, or may be an organic adsorption material, such as a porous polymeric material. Further, the molded adsorbents 50 (50A to 50I) may be also contained in a part or whole of the main chamber 20 and/or the first auxiliary chamber 22a in place of the molded adsorbents 46. Further, although the canister 20 (20A) is configured to define a U-shaped gas passage, it may be possible to define a gas passage having a shape other than a U-shape. For, example, the gas passage may have a straight shape, and the positions of the ports 26, 28, 30 may be changed such that the ports 26, 38 are positioned at one of opposite ends of a cylindrical casing, while the port 30 is positioned at the other of the opposite ends.

The various examples described above in detail with reference to the attached drawings are intended to be representative of the invention and thus not limiting. The detailed description is intended to teach a person of skill in the art to make, use and/or practice various aspects of the present teachings and thus is not intended to limit the scope of the invention. Furthermore, each of the additional features and teachings disclosed above may be applied and/or used separately or with other features and teachings to provide improved molded adsorbents and canisters, and/or methods of making and using the same.

Moreover, the various combinations of features and steps disclosed in the above detailed description may not be necessary to practice the invention in the broadest sense, and are instead taught to describe representative examples of the invention. Further, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed as informational, instructive and/or representative and may thus be construed separately and independently from each other. In addition, all value ranges and/or indications of groups of entities are also intended to include possible intermediate values and/or intermediate entities for the purpose of original written disclosure, as well as for the purpose of restricting the claimed subject matter.

What is claimed is:

1. A molded adsorbent for adsorbing and desorbing a fuel vapor, comprising:
a solid or hollow columnar shaped body with a longitudinal axis and axially opposite end surfaces; and
wherein at least one of the axially opposite end surfaces includes an inclined cut surface portion oriented at an acute angle relative to the longitudinal axis, a concave cut surface portion, or a convex cut surface portion.

2. The molded adsorbent according to claim 1, wherein:
the molded adsorbent has a hollow shaped body and includes a plurality of hollow spaces that are separated from each other by at least one partition wall extending in an axial direction of the molded adsorbent.

3. The molded adsorbent according to claim 1, wherein:
the at least one of the axially opposite end surfaces includes only one inclined cut surface portion.

4. The molded adsorbent according to claim 1, wherein:
the at least one of the axially opposite end surfaces includes a plurality of inclined cut surface portions, wherein each of the plurality of inclined cut surface portions is oriented at an acute angle relative to the longitudinal axis.

5. The molded adsorbent according to claim 4, wherein the plurality of inclined cut surface portions jointly form a serrated shape, a wave shape, a convex V-shape, or a concave V-shape.

6. The molded adsorbent according to claim 1, wherein:
the concave cut surface portion or the convex cut surface portion comprises a plurality of linear projections or grooves arranged parallel to each other in a diametrical direction of the molded adsorbent.

7. The molded adsorbent according to claim 1, wherein the concave cut surface portion or the convex cut surface portion comprises a plurality of stepped portions arranged in a diametrical direction of the molded adsorbent.

8. The molded adsorbent according to claim 1, wherein the molded adsorbent has a uniform sectional shape throughout an axial length thereof.

9. The molded adsorbent according to claim 8, wherein the body of the molded adsorbent has a cylindrical shape.

10. The molded adsorbent according to claim 9, wherein the molded adsorbent has an outer diameter of from 4.0 mm to 6.0 mm.

11. A canister, comprising:
a tank port configured to communicate with a fuel tank;
a purge port configured to communicate with an internal combustion engine;
an atmosphere port configured to communicate with atmosphere;
a first adsorption chamber containing a first adsorbent and communicating with the tank port and the purge port; and
a second adsorption chamber containing a second adsorbent and positioned between the first adsorption chamber and the atmosphere port with respect to a flow of fuel vapor from the tank port to the atmosphere port; wherein
each of the first adsorbent and the second adsorbent is configured to adsorb and desorb the fuel vapor;
the second adsorbent comprises a plurality of molded adsorbents each having a solid or hollow columnar shaped body with a longitudinal axis and axially opposite end surfaces; and
at least one of the axially opposite end surfaces includes an inclined cut surface portion oriented at an acute angle relative to the longitudinal axis, a concave cut surface portion, or a convex cut surface portion.

12. The canister according to claim 11, wherein:
the body of each of the molded adsorbents has a hollow shape and includes a plurality of hollow spaces that are separated from each other by at least one partition wall extending in an axial direction of the molded adsorbent.

13. The canister according to claim 11, wherein:
the at least one of the axially opposite end surfaces of each of the molded adsorbents includes only one inclined cut surface portion.

14. The canister according to claim 11, wherein:
the at least one of the axially opposite end surfaces of each of the molded adsorbents includes a plurality of inclined cut surface portions, wherein each of the plurality of inclined cut surface portions is oriented at an acute angle relative to the longitudinal axis.

15. The canister according to claim 14, wherein the plurality of inclined cut surface portions of each of the molded adsorbents jointly form a serrated shape, a wave shape, a convex V-shape, or a concave V-shape.

16. The canister according to claim 11, wherein:
the concave cut surface portion or the convex cut surface portion of each of the molded adsorbents includes a plurality of linear projections or grooves arranged parallel to each other in a diametrical direction of the molded adsorbent.

17. The canister according to claim 17, wherein the concave cut surface portion or the convex cut surface portion of each of the molded adsorbents includes a plurality of stepped portions arranged in a diametrical direction of the molded adsorbent.

18. The canister according to claim 11, wherein each of the molded adsorbents has a uniform sectional shape throughout an axial length thereof.

19. The adsorbent according to claim 18, wherein the body of each of the molded adsorbents has a cylindrical shape.

20. The adsorbent according to claim 19, wherein each of the molded adsorbents has an outer diameter of from 4.0 mm to 6.0 mm.
